(19) United States
(12) Patent Application Publication
(10) Pub. No.: US 2005/0016803 A1
(43) Pub. Date: Jan. 27, 2005

(54) Multiple stop gas spring for vehicle closure

(76) Inventor: Chad Brummitt, Florence, SC (US)

Correspondence Address: CARLSON, GASKEY & OLDS, P.C., 400 WEST MAPLE ROAD, SUITE 350, BIRMINGHAM, MI, 48009, US

(21) Appl. No.: 10/627,001

(22) Filed: Jul. 25, 2003

(51) Int. Cl. F16F 5/00; F16F 9/48

(52) U.S. Cl. 188/284; 267/64.11

(57) ABSTRACT

This invention provides a fluid spring suitable for use with vehicle closures such as liftgates. The fluid spring includes a cylinder having an inner wall. A piston mounted on a rod end portion is disposed within the cylinder defining compression and expansion chambers. The cylinder wall includes at least one groove defining a travel zone along the length of the groove. Another length of the cylinder wall adjoining the groove defines a stop zone. Under a first force, the fluid spring moves rapidly through the travel zone until it reaches the stop zone. A second force greater than the first force is needed to move the gas spring from the stop zone to the next travel zone. The stop zone corresponds to an open position of a closure such as a liftgate.

### BACKGROUND OF THE INVENTION

This invention relates to a gas spring for a vehicle liftgate or other vehicle closure.

Numerous vehicle closures utilize one or more gas springs to hold the vehicle closure in an open position. Furthermore, the gas spring assists the operator in lifting the vehicle closure, which may be very heavy. One such vehicle closure is a liftgate, which are prevalent in large sport utility vehicles (SUV).

Prior art gas springs move the liftgate between a closed position to an open position upon actuation by the user. Having only one open position is undesirable for several reasons. First, the liftgate of a large SUV may hit the garage door in a standard size garage. Second, for shorter users the liftgate may be out of reach when in the open position.

A typical gas spring includes a piston mounted on an end of a rod, which is disposed within a fluid cylinder. An O-ring and valve disk are mounted on the piston to seal against the inner wall of the cylinder. The piston includes an orifice plate and fluid passages. The O-ring and valve disk permit fluid communication between the compression and extension chambers. The geometry of the valve disk, O-ring, passage, and orifice plate of the piston define the opening characteristics of the liftgate to which the gas spring is attached. Disadvantageously, prior art gas springs only include the closed position and a single open position. Therefore, what is needed is a gas spring providing multiple stop zones corresponding to open positions.

### SUMMARY OF THE INVENTION

This invention provides a fluid or gas spring suitable for use with vehicle closures such as liftgates. The fluid spring includes a cylinder having an inner wall. A piston mounted on a rod end portion is arranged within the cylinder and defines compression and extension chambers. The cylinder wall includes at least one groove defining a travel zone along the length of the groove. Another length of the cylinder wall adjoining the groove defines a stop zone.

At least one of the piston and rod end defines first and second fluid passages. A seal is disposed within the first and second passages for selectively permitting fluid flow as the piston moves into and out of the compression and extension chambers. An outer lip of the seal radially engages the inner cylinder wall.

Under a first force, the fluid spring moves rapidly through the travel zone until it reaches the stop zone. A second force greater than the first force is needed to move the gas spring from the stop zone to the next travel zone. The stop zone corresponds to an open position of a closure such as a liftgate. The end of the cylinder may also provide an additional open position. An inner portion of the seal permits fluid flow from one chamber to the other during the compression stroke as the piston travels the length of the stop zone.

Accordingly, this invention provides a fluid spring with multiple stop zones corresponding to multiple open positions of the vehicle closure.

### BRIEF DESCRIPTION OF THE DRAWINGS

Other advantages of this invention can be understood by reference to the following detailed description when considered in connection with the accompanying drawings wherein:

FIG. 1 is a side elevational view of a schematic of a vehicle having a liftgate;

FIG. 2 is a schematic cross-sectional view of an example of the inventive fluid spring;

FIG. 3 is a cross-sectional view of the cylinder taken along line 3-3 of FIG. 2;

FIG. 4 is an enlarged cross-sectional view of a piston assembly moving through the travel zone during an extension stroke;

FIG. 5 is a cross-sectional view of the piston assembly moving through the stop zone during the extension stroke;

FIG. 6 is a cross-sectional view of the piston assembly moving through the travel zone during a compression stroke; and

FIG. 7 is a cross-sectional view of the piston assembly moving through the stop zone during the compression stroke.

### DETAILED DESCRIPTION OF THE PREFERRED EMBODIMENT

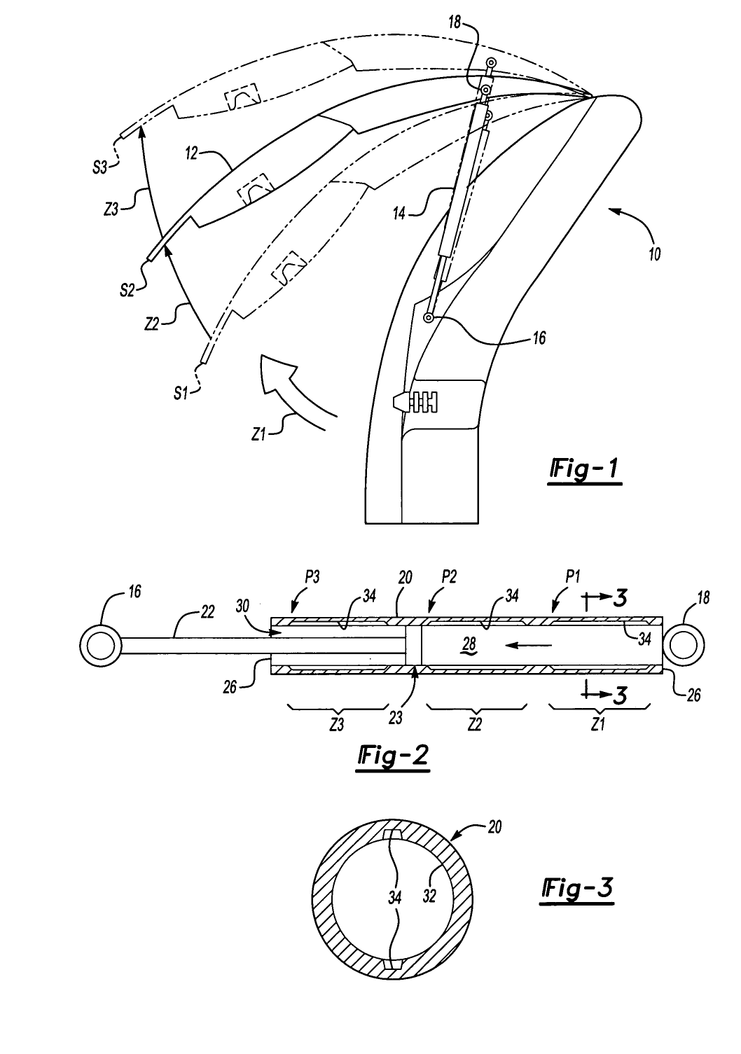

A vehicle 10 is shown in FIG. 1 having a closure such as a liftgate 12. A fluid spring 14 is interconnected between the vehicle body and the liftgate 12 at pivotal connections 16 and 18. In one example of the inventive fluid spring 14, the liftgate 12 may be moved between a closed position and three open positions, respectively depicted at S1-S3. For the illustrated example, the liftgate 12 is moved from the closed position through travel zone Z1 to the first open position S1, in which the liftgate 12 is within reach of a shorter user. The liftgate 12 is movable from the first open position S1 through the second travel zone Z2 to the second open position S2, in which the liftgate 12 is open a greater position, but is still low enough to avoid hitting a garage door for large SUVs parked within a standard sized garage. Liftgate 12 is movable from the second open position S2 to a third travel zone Z3 to a third open position S3 in which the fluid spring 14 is fully extended to maintain the liftgate 12 in a fully opened position providing the greatest access to the vehicle cargo area.

Travel zones are located between the open positions. The travel zones Z1-Z3 require a first actuation force from the user to move between the closed position and the open position S1-S3. To move the liftgate through the open positions S1-S3, a second actuation force is required that is greater than the first actuation force. The open positions S1-S2 correspond to stop zones, which will be described in more detail below.

In operation, the user applies the first actuation force and under the force of the fluid spring 14 and/or slight force by the user, the liftgate 12 moves rapidly through the travel zone until it reaches a stop zone. To move the liftgate 12 from one stop zone to the next, the user applies a second actuation force in which greater force must be applied by the user.

The stop zones and travel zones are described in more detail in FIGS. 2-7. Referring to FIGS. 2 and 3, the fluid spring 14 includes a cylinder 20 with a rod 22 arranged partially within the cylinder 20. The fluid spring 14 includes a piston assembly 23, which includes a piston 24 and an end portion 25 of the rod 22. The piston assembly 23 separates compression 28 and extension 30 chambers. The cylinder 20 includes opposing ends 26, which define the chambers 28 and 30 along with the piston assembly 23 and an inner wall 32 of the cylinder 20.

The cylinder wall 32 may include one or more grooves 34 extending along a length of the cylinder 20. The length of the grooves 34 define the travel zone, as indicated by Z1-Z3 in FIG. 2. The stop zones are defined by the length of cylinder wall 32 between the travel zones Z1-Z3, as indicated by P1 and P2, which correspond respectively to S1 and S2. A stop zone may also be defined by an end 26, as indicated by P3, which corresponds to S3. P3 defines a fully extended gas spring position in which the piston assembly 23 abuts the end 26.

The piston assembly 23 moves through the travel zones Z with relatively low actuation force from the user until it reaches a stop position, at which time the piston assembly 23 ceases relative movement with respect to the cylinder 20.

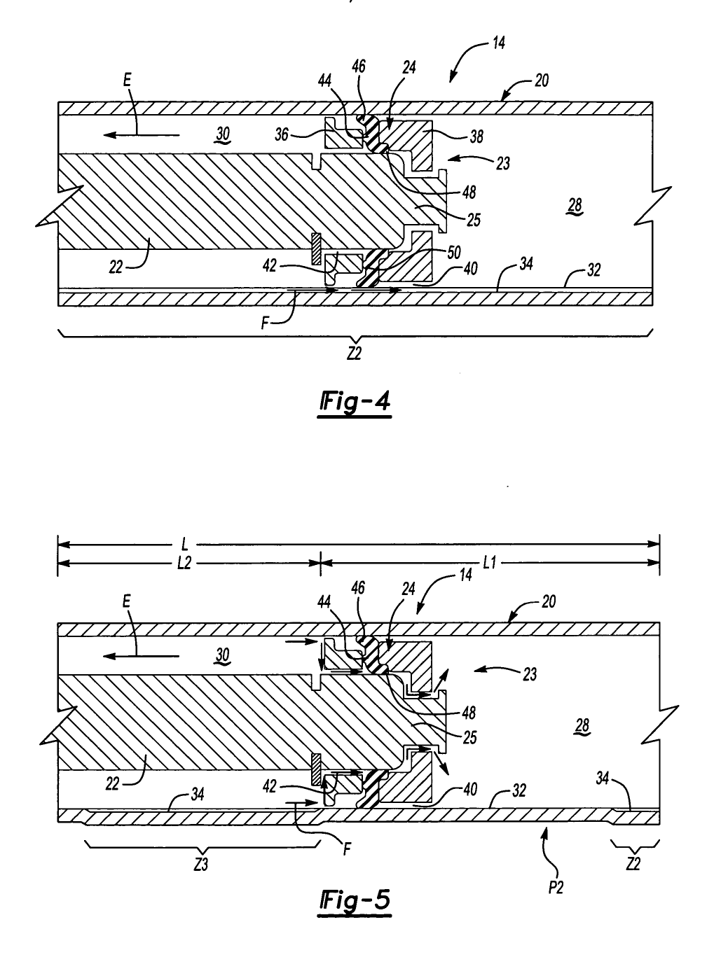

Referring to FIG. 4, the piston 24 may include first portion or cap 36 and second or tacking plate portion 38 secured to one another for ease of assembly and design. The piston assembly 23 which includes the piston 24 and rod end portion 25, includes first 40 and second 42 fluid passages that extend between the compression 28 and extension 30 chambers. In an example illustrated in FIGS. 4-7, the first passage 40 is arranged between the piston 24 and cylinder wall 32. The second passage 42 is shown between the piston 24 and rod end portion 25.

A seal 44 is retained between the first portion or cap 36 and second or backing plate portion 38 for selectively permitting fluid flow through the first 40 and second 42 passages. Although one seal 44 is shown, more than one seal may be used. The seal 44 includes a first outer lip 46 arranged within the first passage 40 and a second inner lip 48 arranged in the second passage 42. The outer lip 46 seals against the inner wall 32. Unlike prior art O-rings, the inventive seal permits only unidirectional flow at the separate lips 46 and 48, which are in opposite flow directions from one another. The seal 44 includes an axial projection 50, which maintains the seal 44 in a desired position with respect to the piston 24 and cylinder 20. The axial projection 50 provides a better seal between the passages 40 and 42.

In the embodiment shown in the Figures, the first lip 46 is angled in a first direction to permit fluid flow in the first direction, and the second lip 48 is angled in a second direction opposite than the first direction to permit fluid flow in the second direction. In this way, the lips 46 and 48 act as check valves.

FIG. 4 depicts fluid flow F from the extension chamber 30 to the compression chamber 20 during an extension stroke E. The piston assembly 23 is shown moving along a travel zone Z2. The fluid F is permitted to bypass the piston assembly 23 and seal 44 by flowing through the groove 34. In this manner, the piston assembly 23 is permitted to move relatively uninhibited through the travel zone Z2 thereby requiring a relatively low initial actuation force, if any.

Once the piston assembly 23 reaches the stop zone P2, a greater reaction force is required to move the piston assembly 23 through the stop zone P2 to the next travel zone Z3. The stop zone P2 is defined by the length L1 through which the liftgate is maintained in the corresponding open position until a force is applied by the user. Once the outer seal 46 reaches the groove 34 in travel zone Z3, the piston assembly 23 begins to move relatively uninhibited through the cylinder 20 until the piston assembly 23 reaches the next stop zone.

As the piston assembly 23 moves through the stop zone P2, the fluid F flows through the second passage 42 deflecting the inner lip 48 so that the fluid F flows from the extension chamber 30 into the compression chamber 28, as shown in FIG. 5. The force required to deflect the lip 48 is greater than the force required to move the fluid F through the groove 34 past the outer lip 46.

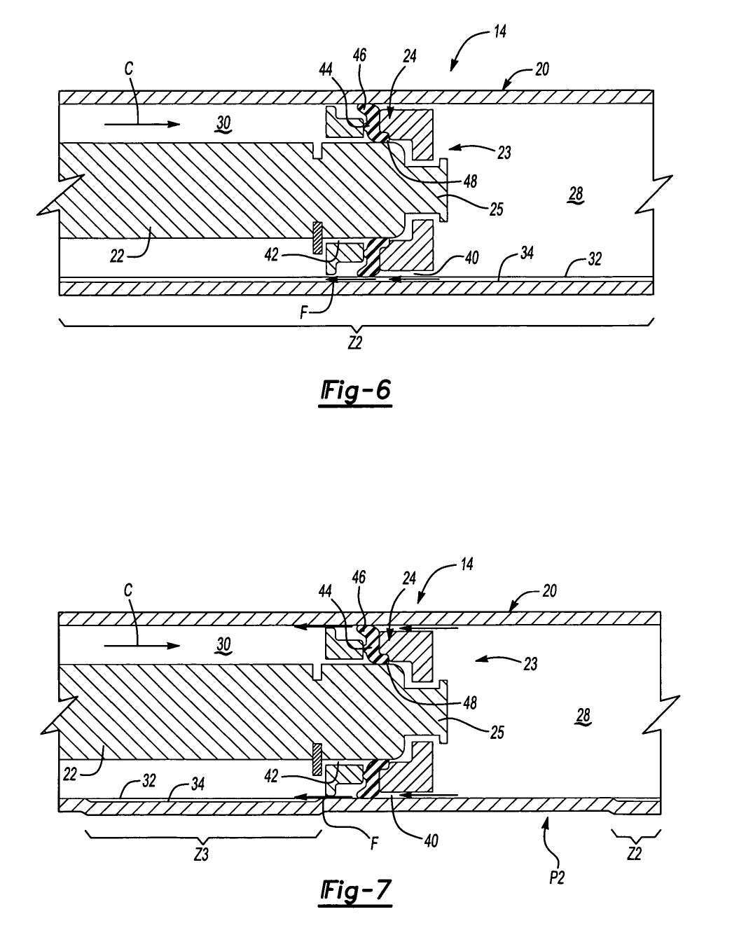

The compression strokes are illustrated in FIGS. 6 and 7. As with the extension stroke through a travel zone, fluid F flows past the outer lip 46 through the groove permitting the piston assembly 23 to move relatively uninhibited through the cylinder 20. To move the piston assembly 23 through the stop zone P2 during the compression stroke C, as shown in FIG. 7, the fluid F deflects the outer lip 46 permitting fluid F to flow from the compression chamber 28 to the extension chamber 30. The force required to deflect the outer lip 46 as the piston assembly 23 moves through the cylinder 20 is greater than the force required to move the fluid F to the groove 34 as the piston 23 moves through a travel zone.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A method of moving a vehicle closure between multiple positions using a fluid spring comprising the steps of:
a) applying a first force to the closure until the closure reaches a first position;
b) maintaining the closure in the first position with a stop zone in the fluid spring without application of an external force;
c) applying a second force greater than the first force to move the closure from the stop zone to a travel zone in the fluid spring; and
d) moving the closure through the travel zone with the fluid spring to a second stop position.

2. The method according to claim 1, wherein the fluid spring includes a cylinder having a groove defining the travel zone.

3. The method according to claim 2, wherein the cylinder includes a length adjoining the groove defining the stop zone.

4. A fluid spring for opening a vehicle closure comprising:
a cylinder having first and second fluid chambers;
a piston assembly disposed in said cylinder and separating said first and second fluid chambers;
a travel zone defined by a first length of said cylinder; and
a stop zone defined by a second length of said cylinder adjoining said first length, said piston assembly maintained in an axial position relative to said cylinder in said stop zone, said piston assembly permitted to move relative to said cylinder in said stop zone in response to a first force, and said piston assembly permitted to move relative to said cylinder in said travel zone in response to a second force less than said first force.

5. The fluid spring according to claim 4, wherein said travel zone includes at least one groove in said cylinder along said first length.

6. The fluid spring according to claim 4, wherein said fluid spring includes multiple travel zones.

7. The fluid spring according to claim 4, wherein said fluid spring includes multiple stop zones.

8. A fluid spring comprising:
a cylinder having an inner wall and opposing ends, said cylinder defining first and second fluid chambers;
a piston comprising a piston and a rod with said rod having an end portion supporting said piston, said piston assembly including first and second passages;
at least one seal supported by said piston assembly and at least partially arranged within said first and second passages selectively permitting fluid flow between said first and second chambers;
a stop zone defined by a length of said cylinder; and
a travel zone defined by a groove in said cylinder adjoining said stop zone with said groove spaced from said seal creating a fluid leak past said piston assembly.

9. The fluid spring according to claim 8, wherein said seal includes first and second opposing lips angled in opposite directions with said first and second lips respectively arranged within said first and second passages, said first lip engaging said inner wall.

10. The fluid spring according to claim 9, wherein said seal includes an axial protrusion arrange the passages in said piston assembly for enhancing sealing between the passages.

11. The fluid spring according to claim 8, wherein said first chamber is a compression chamber and said second chamber is an extension chamber, said fluid flowing through said first passage during a compression stroke and said fluid flowing through said second passage during an extension stroke.

12. The fluid spring according to claim 8, wherein said cylinder includes multiple grooves axially spaced from one another defining multiple travel zones.

13. The fluid spring according to claim 12, wherein said fluid spring includes multiple stop zones.
